(19) United States
(12) Patent Application Publication
(10) Pub. No.: US 2006/0090181 A1
(43) Pub. Date: Apr. 27, 2006

(54) Method and apparatus for pre-processing service information in open cable system

(75) Inventor: Keum-yong Oh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/253,844

(22) Filed: Oct. 20, 2005

(30) Foreign Application Priority Data
Oct. 21, 2004 (KR) 10-2004-0084408

(51) Int. Cl. H04N 5/445; G06F 13/00; G06F 3/00

(52) U.S. Cl. 725/39

(57) ABSTRACT

A method and apparatus for pre-processing service information (SI) in digital cable broadcasting are provided. A digital cable broadcast receiver includes a point-of-deployment (POD) module which provides service information (SI) data transmitted by a head end to a demultiplexer, the demultiplexer which extracts one or more section tables required for reconstructing channel information and program event information by demultiplexing the SI data and provides raw section table data regarding the extracted section tables, and an SI processing module which obtains SI data required for reconstructing the channel information and the program event information by processing the raw section table data and stores the SI data in a memory.

### CROSS-REFERENCE TO RELATED APPLICATION

This application claims priority from Korean Patent Application No. 10-2004-0084408 filed on Oct. 21, 2004, the disclosure of which is incorporated herein in its entirety by reference.

### BACKGROUND OF THE INVENTION

1. Field of the Invention

The present invention relates to a digital cable broadcast system, and more particularly, to a method and apparatus for pre-processing service information (SI) included in an out-of-band channel and transmitted by a head end of an open cable system.

2. Description of the Related Art

Along with the recent development of information communication technology, broadcasting services are digitalized. The digital broadcasting service provides high quality broadcasting programs and is advantageous to the transmission of high-rate broadcasting data such as an electronic program guide. Currently, digital broadcast programs are typically provided by satellite broadcasters, terrestrial broadcasters, and cable broadcasters.

In particular, since the digital cable TV service system is most advantageous to interactive TV services and transmission of a large amount of data compared to other types of digital broadcasting, it is expected to provide a variety of multimedia services, such as Internet access services, data broadcast services, video-on-demand (VOD) services, and electronic commerce services.

In recent years, the transmission standards for digital cable TV service include the Open Cable standard in the US, DVB-C (Digital Video Broadcasting-Cable) standard in Europe, and ISDB-C (Integrated Services Digital Broadcasting for Cable) standard in Japan, etc.

In OpenCable digital cable broadcasting, data is transmitted by a head end via an in-band channel and an out-of-band channel. In detail, video data compressed in a Motion Picture Experts Group (MPEG) 2 and audio data compressed in Audio Coding (AC) 3 are provided via an in-band channel. On the other hand, service information (SI), including an electronic program guide (EPG), weather forecasts, newscasts, sportscasts, traffic information, TV electronic commerce (T-Commerce) information, channel information, program information, program title information, and broadcasting hours information, is provided via an out-of-band channel as a section table. Accordingly, subscribers can carry out bidirectional communication by using the SI with the aid of an OpenCable application platform (OCAP) application or an EPG application.

FIG. 1 is a flowchart illustrating a conventional method of processing SI in a digital cable broadcast receiver. Referring to FIG. 1, in operation S110, if a request for an EPG is issued by a user, a digital cable broadcast receiver extracts one or more section tables regarding an EPG from received SI. In operation S120, an EPG is generated based on the extracted section tables. In operation S130, the EPG is displayed on the screen of, for example, a TV or a monitor.

In the conventional method, however, if data requested by the user is not configured in advance in the received SI, the requested data and one or more section tables for reconstructing the requested data must be filtered and then appropriately processed, and thus, it generally takes long to display the requested data.

### SUMMARY OF THE INVENTION

The present invention provides a method and apparatus for pre-processing service information (SI) in digital cable broadcasting, which can reduce the time taken to display SI requested by a user by pre-processing SI data regarding the requested SI.

The above stated object as well as other objects, features and advantages, of the present invention will become clear to those skilled in the art upon review of the following description.

According to an aspect of the present invention, there is provided a digital cable broadcast receiver including a point-of-deployment (POD) module which provides service information (SI) data transmitted by a head end to a demultiplexer, the demultiplexer which extracts one or more section tables required for reconstructing channel information and program event information by demultiplexing the SI data and provides raw section table data regarding the extracted section tables, and an SI processing module which obtains SI data required for reconstructing the channel information and the program event information by processing the raw section table data and stores the SI data in a memory.

According to another aspect of the present invention, there is provided a method of pre-processing SI in digital cable broadcasting including generating raw data by demultiplexing SI data and then providing the raw data, obtaining SI data necessary for reconstructing information by processing the raw data, storing the SI data in a memory, and generating an EPG based on the SI data stored in the memory in response to a request for SI data and outputting the EPG.

### BRIEF DESCRIPTION OF THE DRAWINGS

The above and other features and advantages of the present invention will become more apparent by describing in detail preferred embodiments thereof with reference to the attached drawings in which:

FIG. 1 is a flowchart illustrating a conventional method of processing service information (SI) in a digital cable broadcast receiver;

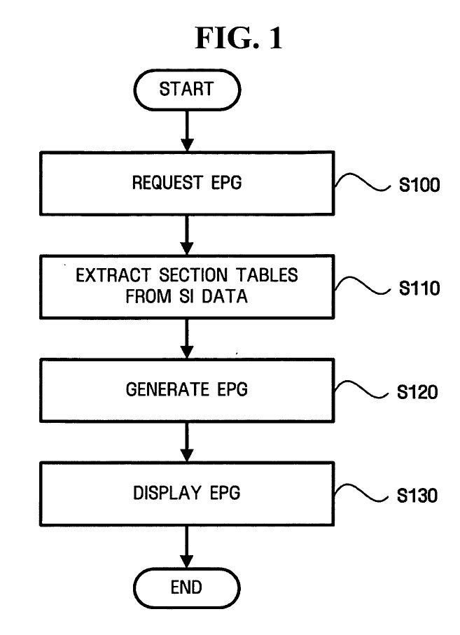

FIG. 2 is a block diagram of a digital cable broadcast system to which the present invention is applied;

FIG. 3 is a block diagram of a digital cable broadcast receiver according to an exemplary embodiment of the present invention;

FIG. 4 is a detailed block diagram of an SI processor of a digital cable broadcast receiver according to an exemplary embodiment of the present invention; and

FIG. 5 is a flowchart illustrating a method of pre-processing SI in a digital cable broadcast receiver according to an exemplary embodiment of the present invention.

### DETAILED DESCRIPTION OF THE INVENTION

The present invention will now be described more fully with reference to the accompanying drawings, in which preferred embodiments of this invention are shown. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein.

Rather, these embodiments are provided so that this disclosure will be thorough and complete and will fully convey the concept of the invention to those skilled in the art, and the present invention will only be defined by the appended claims. Like reference numerals refer to like elements throughout the specification.

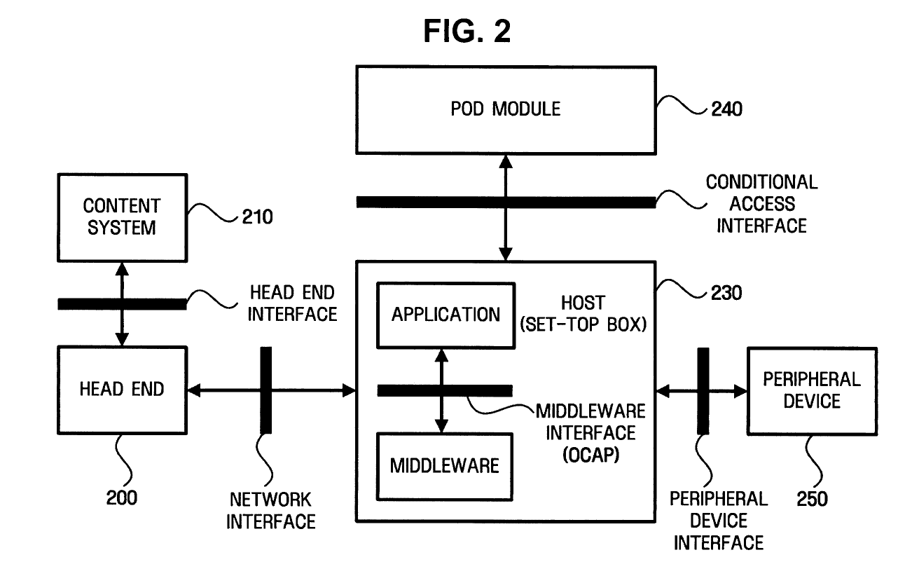

FIG. 2 is a block diagram of a digital cable broadcast system according to an exemplary embodiment of the present invention. Referring to FIG. 2, the digital cable broadcast system includes a head end 200, a content system 210, a digital cable broadcast receiver 230, which is a host device, and a peripheral device 250, such as a display device.

The content system 210 provides content information regarding a series of TV broadcasts provided by the head end 200, for example, the program title, starting time, and the like, of the TV program.

The head end 200, which is a broadcast station, produces a digital broadcast signal and transmits an MPEG-2 transport stream (TS) comprising a video signal compressed in an MPEG-2 format and an audio signal compressed in an AC-3 format to the digital cable broadcast receiver 230. The head end 200 also transmits not only audio/video (A/V) data of a broadcast program but also service information (SI) regarding the broadcast program.

Program and System Information Protocol (PSIP) suggested by the Advanced Television System Committee (ATSC) has been adopted as a digital TV broadcasting standard and Out-Of Band for Service Information (OOBSI) proposed by the Society of Cable Telecommunications Engineers (SCTE) has been adopted as a digital TV broadcasting standard. PSIP can provide an electronic program guide (EPG) information and SI together.

In detail, PSIP and OOBSI comprise a plurality of tables that enable the transmission of A/V data comprised of MPEG-2 video data and AC-3 audio data and the transmission of other data, such as channel information regarding a plurality of channels provided by each broadcasting station and program information regarding a plurality of programs carried over each of the channels. In addition, PSIP provides A/V data regarding a broadcast program desired by a user together with an EPG regarding the desired broadcast program.

PSIP and OOBSI include a plurality of section tables, i.e., the Virtual Channel Table (VCT) including the Short Virtual Channel Table (SVCT) and the Long Virtual Channel Table (LVCT), the Network Text Table (NTT), the Network Information Table (NIT), the Rating Region Table (RRT), the Master Guide Table (MGT), the Aggregate Event Information Table (AEIT), the Aggregate Event Text Table (AETT), and the System Time Table (STT).

The NTT, the NIT, and the VCT include channel information (i.e, CDS_record( ) included in NIT, CDS_reference included in SVCT, carrier_frequency included in LVCT, source_name included in NTT, virtual_channel_number included in SCVT, and major_chnnel_number and minor_channel_number included in LVCT), broadcast program information (service_type), channel transmission modulation information (MMS_record included in NIT and MMS_reference included in SVCT), and source identifier information (source_id) regarding each of a plurality of broadcast programs. A digital cable broadcast receiver can obtain an EPG information (i.e., event_ID, start_time, title_text( )) from the AEIT using the source identifier information. The AETT includes additional channel information (extended_text_message( )) and additional broadcast program information, such as short descriptions of the broadcast programs. The RRT includes rating information (rating_region_name_text( ), dimension_name_text( )), and the STT includes broadcasting hour information of the broadcast programs and weather information (system_time, GPS_UTC_offset). The MGT includes version and packet identifier (PID) information (table_type, table_type_PID) of the other section tables of PSIP.

The MGT, the STT, the RRT, and the VCT are carried over a plurality of transport packets having the same PID, and the AEIT and the AETT are carried over a plurality of transport packets having different PIDs.

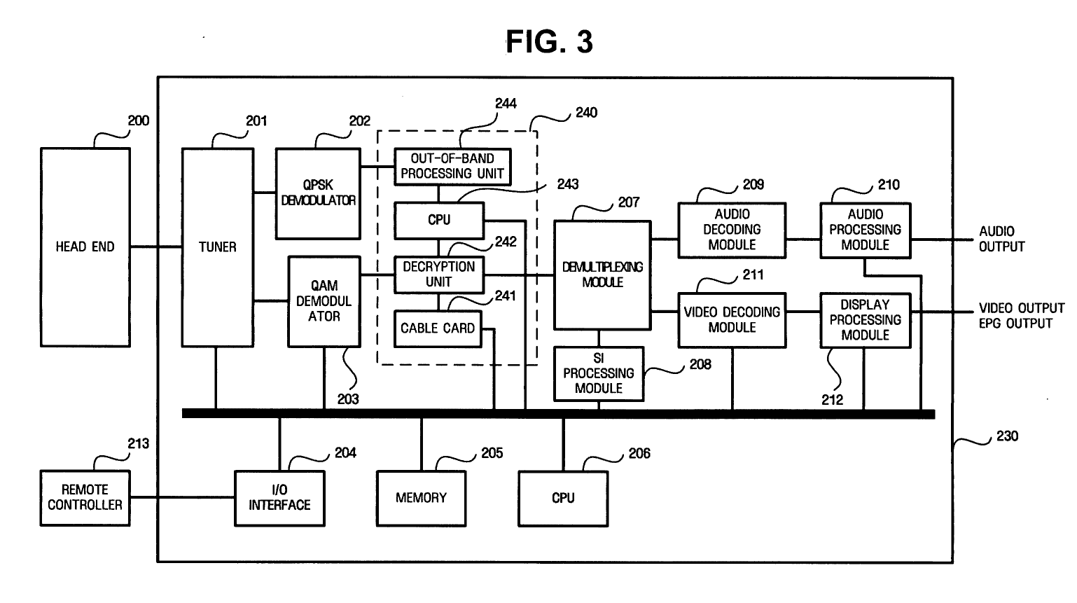

FIG. 3 is a block diagram of a digital cable broadcast receiver 230 according to an exemplary embodiment of the present invention. Referring to FIG. 3, the digital cable broadcast receiver 230 may be an exterior set-top box separate from a TV or an embedded set-top box installed in a TV.

The digital cable broadcast receiver 230 includes a host 230, which is the main body of a set-top box, and a point-of-deployment (POD) module 240, which performs a conditional access system (CAS) function.

A broadcast signal transmitted by the head end 200 not only includes A/V data regarding a TV program but also includes SI which is used for displaying an EPG. The broadcast signal is transmitted to a tuner 201 via a cable.

The tuner 201 synchronizes itself with a reception bandwidth chosen by a user of the digital cable broadcast receiver 230, converts the broadcast signal into an intermediate frequency (IF) signal, and transmits the IF signal to a demodulation unit comprising a quadrature phase-shift keying (QPSK) demodulator 202 and a quadrature amplitude modulation (QAM) demodulator 203. If the IF signal is an in-band signal, the tuner 201 transmits the IF signal to the QAM demodulator 203. On the other hand, if the IF signal is an out-of-band signal, the tuner 201 transmits the IF signal to the QPSK demodulator 202.

The demodulation unit demodulates a digital signal provided by the tuner 201 as an MPEG-2 TS and provides the MPEG-2 TS to a demultiplexing module 207.

The demultiplexing module 207 extracts audio data and video data corresponding to a predetermined service from the MPEG-2 TS provided by the demodulation unit and provides the audio data and the video data to an audio decoding module 209 and a video decoding module 211, respectively.

The audio decoding module 209 generates program audio data by decoding the audio data provided by the demultiplexing module 207 and provides the program audio data to an audio processing module 210. The audio processing module 210 processes the program audio data and outputs the processed program audio data via an amplifier.

The video decoding module 211 generates program video data by decoding the video data provided by the demultiplexing module 207 and provides the program video data to a display processing module 212.

The display processing module 212 generates an output image by processing the program image data provided by the video decoding module 211. In addition, the display processing module 212 lays text information over a program image displayed on the screen of a display device, such as a TV.

The POD module 240 includes an out-of-band processing unit 244, a decryption unit 242, a cable card 241, and an additional central processing unit (CPU) 243.

The decryption unit 242 is controlled by a CPU 206 of the digital cable broadcast receiver 230. If an MPEG-2 TS transmitted by a broadcasting station is encrypted, the decryption unit 242 decrypts the MPEG-2 TS and provides the decrypted MPEG-2 TS to the demultiplexing module 207.

The cable card 241 is distributed to the user by a service center that is affiliated with a broadcasting business operator. The cable card 241 stores user contract information, which specifies an agreement contracted by the user and the broadcasting business operator. The content of the user contract information may vary from one subscriber to another subscriber. If the user chooses a conditional access broadcast program and the user contract information stored in the cable card 241 includes information regarding a contract on the conditional access broadcast program, an MPEG-2 TS related to the conditional access broadcast program can be decrypted by using decryption information obtained from the user contract information and a broadcast signal, so the user can watch the conditional access broadcast program. However, if the user contract information stored in the cable card 241 does not specify any contract on the conditional access broadcast program, the MPEG-2 TS related to the conditional access broadcast program cannot be decrypted, so the user cannot watch the conditional access broadcast program.

An out-of-band signal received via the tuner 201 is demodulated by the QPSK demodulator 202, and the demodulated out-of-band signal is processed by the out-of-band processing unit 244 inside the POD module 240. Thereafter, the processed result is provided to the demultiplexing module 207 via a cable card interface, e.g., an extended channel.

The demultiplexing module 207 extracts a plurality of section tables required for reconstructing channel information or program event information from a signal provided by the POD module 240. The section tables extracted by the demultiplexing module 207 are raw data and thus are processed by the SI processing module 208, thereby obtaining SI data required for reconstructing channel information and program information. Thereafter, the SI data is stored in a memory 205, which is controlled by the CPU 206. The memory 205 also stores EPG text data and graphic data (e.g., a program table frame and the logo marks of broadcast channels) used for displaying an EPG.

The section tables extracted by the demultiplexing module 207 may vary according to user settings. In other words, if the user sets predetermined SI as favorite SI, the demultiplexing module 207 extracts one or more section tables necessary for reconstructing the predetermined SI. For example, if the user sets program synopsis information as favorite SI, the demultiplexing module 207 extracts raw section table data regarding one or more section tables necessary for reconstructing the program synopsis information. Thereafter, the SI processing module 208 obtains SI data necessary for reconstructing the program synopsis information from the extracted raw section table data and stores the SI data in the memory 205. If the user requests the program synopsis information again, the program synopsis information may be reconstructed from the SI data stored in the memory 205.

In addition, if predetermined information, e.g., channel information, may be set as default information, one or more section tables necessary for reconstructing the channel information may be automatically extracted whenever the demultiplexing module 207 extracts section tables.

A command input by the user with the aid of an input device, such as a remote controller 213, is input to the CPU 206 via an input/output interface 204.

The CPU 206 controls all of the modules inside the digital cable broadcast receiver 230 under the control of the user. For example, the user may send a command to synchronize with the frequency of a predetermined channel to the tuner 201. In the case of displaying an EPG, the CPU 206 produces EPG text data and graphic data using the SI data stored in the memory 205 and provides the EPG text data and the graphic data to the display processing module 212.

The display processing module 212 outputs program image data provided by the video decoder 212 to a TV so that the program image data can be displayed on the screen of a TV. The display processing module 212 may also output the EPG text data and the graphic data provided by the CPU 206 to the TV so that the EPG text data and the graphic data can be laid over the program image data displayed on the screen of the TV.

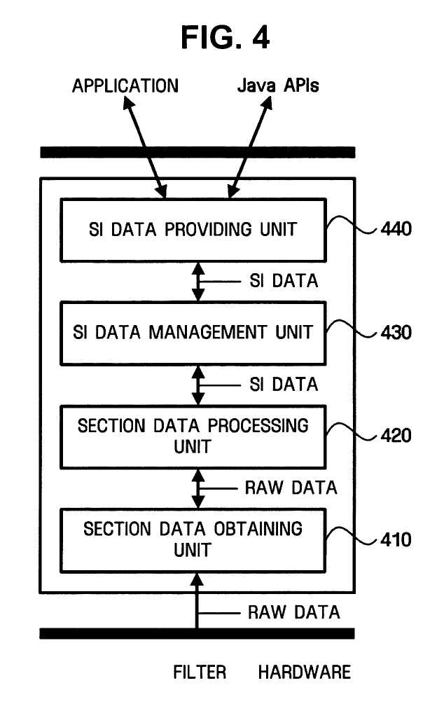

FIG. 4 is a detailed block diagram of the SI processing module 208 of FIG. 3. Referring to FIG. 4, the SI processing module 208 includes a section data obtaining unit 410, a section data processing unit 420, an SI data management unit 430, and an SI data providing unit 440.

The section data obtaining unit 410 obtains raw section table data required for reconstructing favorite SI set by the user from the demultiplexing module 207 and transmits the raw section table data to the section data processing unit 420. For example, if channel information and program event information are set by the user as the favorite SI, the demultiplexing module 207 extracts one or more section tables required for reconstructing the channel data and the program event information and then provides raw section table data regarding the extracted section tables to the section data obtaining unit 410.

The section data processing unit 420 processes the raw section table data provided by the section data obtaining unit 410, thereby obtaining SI data required for reconstructing the favorite SI. Thereafter, the section data processing unit 420 provides the SI data to the SI data management unit 430.

The SI data management unit 430 stores the SI data provided by the section data processing unit 420 in the memory 205 and manages the stored SI data.

The SI data providing unit 440 generates an EPG from the SI data stored in the memory 205 and outputs the EPG using a Java API if the user issues a request for SI data.

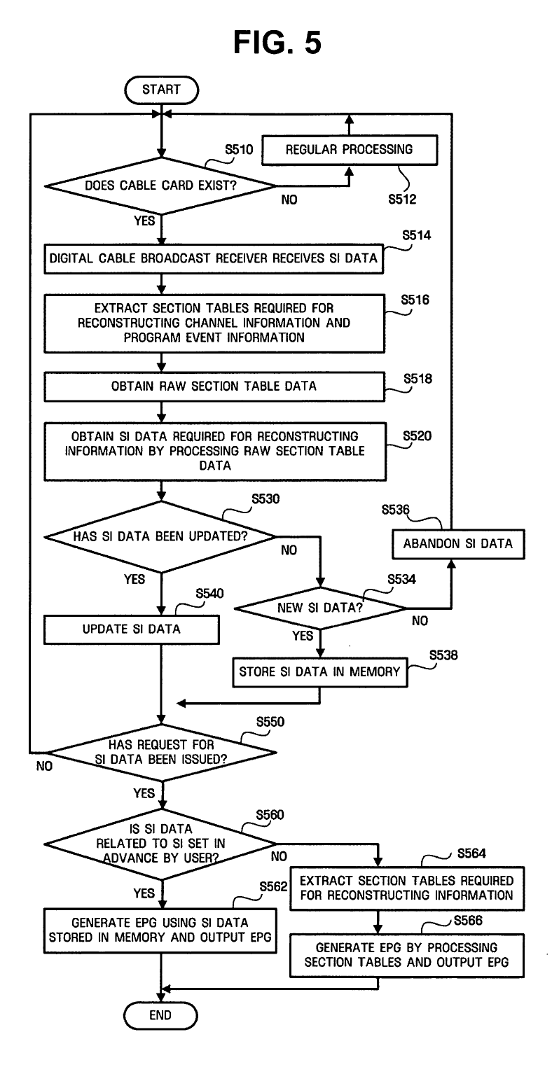

As described above, the processing of SI data by the digital cable broadcast receiver 230 including the SI processing module 208 will now be described in detail with reference to FIG. 5.

Referring to FIG. 5, in operation S510, it is determined whether the POD module 240 (particularly, the cable card 241) exists in the digital cable broadcast receiver 230. In operation S512, if no cable card exists in the digital cable broadcast receiver 230, the digital cable broadcast receiver 230 cannot process SI data received via an out-of-band channel and also cannot decrypt an encrypted MPEG-2 TS transmitted by a head end.

In operation S514, if the cable card 241 is determined to exist in the digital cable broadcast receiver 230, the SI data received via the out-of-band channel is processed through by the out-of-band processing module 244 and then is transmitted to the demultiplexing module 207 via an extended channel.

In operation S516, the demultiplexing module 207 demultiplexes the SI data, thereby extracting one or more section tables required for reconstructing predetermined SI set by the user as favorite SI or set as default SI. For example, if channel information is set as default SI and program event information is set by the user as favorite SI, the demultiplexing module 207 extracts the SVCT, the NIT, the NTT, and the LVCT for reconstructing the channel information, extracts the MGT for reconstructing the program event information, and extracts the AEIT and the AETT using a PID of the MGT. Thereafter, the demultiplexing module 207 provides raw section table data regarding the section tables extracted in operation S516 to the SI processing module 208.

In operation S518, the section data obtaining unit 410 of the SI processing module 208 receives the raw section table data from the demultiplexing module 207 and provides the raw section table data to the section data processing unit 420.

In operation S520, the section data processing unit 420 obtains SI data necessary for reconstructing, for example, the channel information and the program event information, by processing the raw section table data.

In operation S530, the SI data management unit 430 compares the SI data obtained in operation S520 with SI data previously stored in the memory 205 and determines whether the comparison results indicate that the SI data previously stored in the memory 205 has been updated.

In operation S540, if the comparison results indicate that the SI data previously stored in the memory 205 has been updated, for example, if the comparison results indicate that section table version information or section table content of the SI data previously stored in the memory 205 has been updated, the SI data management unit 430 updates the SI data previously stored in the memory 205 with reference to the SI data obtained in operation S520. In operation S530, the SI data obtained in operation S520 and the SI data previously stored in the memory 205 may be compared with each other content-wise or size-wise.

For example, if the size of the SI data obtained in operation S520 is different from the size of the SI data previously stored in the memory 205, the SI data management unit 430 may decide to update the SI data previously stored in the memory 205 with reference to the SI data obtained in operation S520.

In operation S534, if the comparison results do not indicate that the SI data previously stored in the memory 205 has been updated, the SI data management unit 430 determines whether the SI data obtained in operation S520 is newer than the SI data stored in the memory 205. In operation S538, if the SI data obtained in operation S520 is determined to be newer than the SI data stored in the memory 205, the SI data management unit 430 stores the SI data obtained in operation S520 in the memory 205. In operation S536, however, if the SI data obtained in operation S520 is determined not to be newer than the SI data stored in the memory 205, in other words, if the SI data obtained in operation S520 is the same as the SI data stored in the memory 205, the SI data management unit 430 abandons the SI data obtained in operation S520.

In operation S550, the CPU 206 determines whether a request for SI data has been issued using, for example, Java APIs.

In operation S560, if a request for SI data is determined to have been issued, the CPU 206 determines whether the requested SI data is related to the default SI or the favorite SI set by the user, i.e., the channel information or the program event information. In operation S562, if the requested SI data is determined to be related to the default SI or the favorite SI set by the user, i.e., the channel information or the program event information, an EPG is generated based on the SI data stored in the memory 205. In operation S562, the EPG is displayed using, for example, a TV.

In operation S564, however, if the requested SI data is determined not to be related to the default SI or the favorite SI set by the user, i.e., the channel information or the program event information, the CPU 206 generates a control signal and controls the demultiplexing module 207 using the control signal to extract one or more section tables required for reconstructing the requested SI data. In operation S566, an EPG is generated by processing the section tables extracted in operation S564 and then is displayed using, for example, a TV.

As described above, according to the present invention, it is possible to reduce response time required for generating an EPG in response to a user request for SI data by pre-processing SI data transmitted via an out-of-band channel and then storing the pre-processed SI data in a memory.

Although the method and apparatus for pre-processing service information (SI) in digital cable broadcasting have been described in connection with an exemplary embodiment of the present invention, it will be apparent to those skilled in the art that various modifications and changes may be made thereto without departing from the scope and spirit of the invention. Therefore, it should be understood that the above embodiments are not limitative, but illustrative in all aspects.

What is claimed is:

1. A digital cable broadcast receiver comprising:
a point-of-deployment (POD) module which provides service information (SI) data transmitted by a head end to a demultiplexer;
the demultiplexer which extracts one or more section tables required for reconstructing channel information and program event information by demultiplexing the SI data and provides raw section table data regarding the extracted section tables; and
an SI processing module which obtains SI data required for reconstructing the channel information and the program event information by processing the raw section table data and stores the SI data in a memory.

2. The digital cable broadcast receiver of claim 1, wherein the SI processing module comprises:
a section data obtaining unit which obtains the raw section table data;
a section data processing unit which obtains the SI data by processing the raw section table data;
an SI data management unit which stores the SI data in the memory and manages the SI data; and
an SI data providing unit which generates an EPG using the SI data and outputs the EPG.

3. A method of pre-processing service information (SI) in digital cable broadcasting comprising:
generating raw data by demultiplexing SI data and then providing the raw data;
obtaining SI data necessary for reconstructing information by processing the raw data;
storing the SI data necessary for reconstructing information in a memory; and
generating an EPG based on the SI data stored in the memory in response to a request for SI data and outputting the EPG.

4. The method of claim 3, wherein the storing comprises comparing the SI data necessary for reconstructing information with SI data previously stored in the memory and updating the SI data previously stored in the memory with reference to the SI data necessary for reconstructing information according to the comparison results.

5. The method of claim 4 further comprising storing the SI data necessary for reconstructing information in the memory according to the comparison results.
